(19) United States
(12) Patent Application Publication
(10) Pub. No.: US 2024/0303681 A1
(43) Pub. Date: Sep. 12, 2024

(54) VIRTUAL USER EXPERIENCE SYSTEMS AND METHODS

(71) Applicant: ULTRAFAN HOLDINGS LIMITED, Tring (GB)

(72) Inventors: Johannes Wessel Greeff, Cape Town (ZA); Templar Wales, Johannesburg (ZA); Michael John Allen, Plettenberg Bay (ZA)

(21) Appl. No.: 18/599,774

(22) Filed: Mar. 8, 2024

Related U.S. Application Data
(60) Provisional application No. 63/489,525, filed on Mar. 10, 2023.

(51) Int. Cl. G06Q 30/0201

(52) U.S. Cl. CPC G06Q 30/0206; G06Q 2220/00

(57) ABSTRACT

Systems and methods for causing generation of non-fungible tokens (NFTs) associated with respective physical spaces of a geographic location are provided. Such NFTs can be minted to include an indication of event data for events corresponding to the physical spaces. A plurality of digital elements can be generated that are each associated with a respective physical space of a plurality of physical spaces of a geographic area. Event data can be received for a first plurality of events associated with the plurality of physical spaces. First and second instructions can be sent to a blockchain to execute respective first and second smart contracts thereby causing generation of a plurality of NFTs each comprising a respective digital element of the plurality of digital elements and indications of values of the NFTs that are based on their digital elements.

### CROSS REFERENCE TO RELATED APPLICATIONS

This application claims the benefit of and priority to U.S. Provisional Patent Application No. 63/489,525, filed on Mar. 10, 2023, entitled “VIRTUAL USER EXPERIENCE SYSTEMS AND METHODS,” the entire contents of which are hereby incorporated by reference herein their entirety.

### FIELD OF THE INVENTION

The subject matter of this application relates generally to using distributed ledger technology to generate and manage digital assets, and, more specifically, to techniques and supporting systems for causing generation of non-fungible tokens (NFTs) corresponding to physical spaces of a geographic location and associating the NFTs with events corresponding to the physical spaces.

### BACKGROUND

Blockchains are generally digital data structures that facilitate recording digital information, and may serve as a public ledger for transactions or a private database. Using cryptography, blockchains allow participants to publish digital information in a secure and immutable way. More specifically, blockchains are designed to be resistant to modification of data once recorded and may not be altered retroactively. Such attributes make the use of blockchain technology very attractive with applications that are transaction dependent.

“Smart contracts” can refer to contracts developed for use with blockchain technologies, where a smart contracts is a self-executing agreement that can execute based on its included terms and conditions. Once added to a blockchain, a smart contract may not be able to be revoked, denied, or reversed and the smart contract can execute independently of off-chain events. Other transactions may interact with a smart contract to cause execution of functions included in and/or otherwise defined by the smart contract.

One use of blockchain and smart contract technology is the generation and tracking of non-fungible tokens (“NFTs”), which are digital assets that can be used to uniquely represent a real-world object such as art, music, collectables, etc. Smart contracts can be used to generate (e.g., mint) a digital asset as an NFT, where the NFT is stored (e.g., recorded) on a blockchain and can uniquely identify the minted digital asset.

### SUMMARY

Disclosed herein are methods and systems for defining and causing generation of NFTs associated with physical spaces of a geographic location. A digital representation of a geographic area (e.g., a playing area for a sporting event) can be segmented into a number of segments each including a portion of the digital representation of the geographic area. Each segment can define boundaries of an actual, physical space within the geographic area, such that each segment corresponds to a two-dimensional or three-dimensional portion of the geographic area. The physical spaces defined by the segments may form the entirety of the geographic area, where (i) the physical spaces are overlapping or non-overlapping and (ii) the physical spaces have the same or variable dimensions. As an example, each of the physical spaces defined by the segments may have the same dimensions and be non-overlapping, such that each physical space occupies a unique portion of the geographic area. Events may take place within the geographic area and included physical spaces, such that one or more of the physical spaces can be associated with the respective events that take place within the physical spaces. Accordingly, smart contracts may be used in combination with a virtual user experience platform to cause generation of NFTs that are associated with the physical spaces of the geographic area (e.g., via digital elements including segments of the digital representation of the geographic area). The NFTs may be minted and/or re-minted to include indications of events occurring within their respective associated physical spaces, thereby enabling generation of NFTs that record and track event data associated with physical spaces. Further, events may be assessed according to an assessment system based on event types and physical space types, such that a value of an NFT and related physical space may be assessed in comparison with values of the other NFTs and related physical spaces of the geographic area, as well as other NFTs corresponding to other geographic areas. These techniques may be employed for use with geographic areas for playing areas associated with sporting events, such that events of the sporting events taking place within the playing areas can be tracked and mapped to physical spaces over time. While the techniques described herein are described in the exemplary context of playing areas of sporting events, one of ordinary skill in the art will recognize that these techniques can be applied for other geographic areas and related events.

In one aspect, the subject matter described herein relates to a computer-implemented method for generating NFTs associated with physical spaces. In one aspect, the method can include generating a plurality of digital elements, where each of the plurality of digital elements is associated with a respective physical space of a plurality of physical spaces of a geographic area. The method can include sending, to a blockchain, first instructions to execute a first smart contract, thereby causing generation of a plurality of non-fungible tokens (NFTs) each including a respective digital element of the plurality of digital elements. The method can include receiving first event data for a first plurality of events associated with the plurality of physical spaces, where each of the first plurality of events includes a respective event type of at least two event types. The method can include determining a value of a first NFT of the plurality of NFTs based on (i) the first event data and (ii) the digital element of the first NFT. The method can include sending, to the blockchain, second instructions to execute a second smart contract, thereby causing the first NFT to include an indication of the value of the first NFT.

Various embodiments of the method can include one or more of the following features. A sporting event may take place and/or occur on the geographic area and/or within the geographic area. The generating the plurality of digital elements can further include generating a plurality of segments of a digital representation of the geographic area, where (i) each of the plurality of digital elements includes a respective segment of the plurality of segments, and (ii) each of the plurality of segments defines (e.g., via coordinate boundaries) a respective physical space of the plurality of physical spaces of the geographic area. In some variations, the plurality of NFTs may be recorded on the blockchain and each of the plurality of NFTs includes a unique digital element of the plurality of digital elements. The first event data can include temporal data derived from a first time period at the geographic area. The first event data can include geospatial data identifying a number of geographic locations within the first a first geographic location within the geographic area associated with at least one event of the first plurality of events. In some variations, each event of the first plurality of events can take place at, on, above, and/or within a respective physical space of the plurality of physical spaces.

In some embodiments, the determining the value of the first NFT of the plurality of NFTs can further include identifying, based on the digital element of the first NFT, a first physical space of the plurality of physical spaces is associated with the digital element of the first NFT, identifying, based on the first event data, at least one event of the first plurality of events is associated with the first physical space, and determining, based on the event type of the at least one event, a value of the digital element associated with the first physical space, where the value of the first NFT is equivalent to the value of the digital element associated with the first physical space. The method may also include determining a value of a second NFT of the plurality of NFTs based on (i) the first event data and (ii) the digital element of the second NFT, and sending, to the blockchain, third instructions to execute a third smart contract, thereby causing the second NFT to include an indication of the value of the second NFT. The method may also include receiving second event data for a second plurality of events associated with the plurality of physical spaces, where each of the second plurality of events includes a respective event type of the at least two event types, determining an updated value of the first NFT based on (i) the first event data, (ii) the second event data, and (iii) the digital element of the first NFT, and sending, to the blockchain, third instructions to execute the second smart contract, thereby causing the first NFT to include an indication of the updated value of the first NFT.

In some embodiments, the plurality of physical spaces can non-overlapping and/or overlapping. Each of the plurality of physical spaces can include (i) a two-dimensional segment of the geographic area or (ii) a three-dimensional segment of the geographic area. In some variations, the first time period can correspond to a sporting event. The method may also include comparing the geospatial data to a plurality of segments of a digital representation of the geographic area, where each of the plurality of segments defines a respective physical space of the plurality of physical spaces of the geographic area, and determining, based on the comparison, the at least one event of the first plurality of events is associated with a first physical space of the plurality of physical spaces. In some variations, the first physical space includes the first geographic location. The value of the first NFT (i) can be based on each of the first plurality of events associated with the first physical space and (ii) can include a numerical assessment of each of the first plurality of events associated with the first physical space. In some variations, execution of the second smart contract is configured to cause the first NFT to include (i) the indication of the value of the first NFT and (ii) an indication of the at least one event associated with the first physical space. In some variations, the determining the value of the digital element associated with the first physical space can be based on (i) the event type of the at least one event and (ii) a physical space type of the first physical space.

Other aspects of the disclosure comprise systems implemented in various combinations of computing hardware and software to achieve the methods described herein.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present embodiments. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present embodiments.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosure. In the following description, various embodiments of the present disclosure are described with reference to the following drawings, in which:

FIG. 1 is an exemplary system diagram illustrating a blockchain, according to some embodiments.

FIG. 2 shows an exemplary system diagram of nodes associated with a blockchain and storing the ledger of the blockchain, according to some embodiments.

FIG. 3 is an exemplary system diagram illustrating validator nodes associated with a blockchain, according to some embodiments.

FIG. 4 is a diagram illustrating an exemplary smart contract, according to some embodiments.

FIG. 5 shows a block diagram of a virtual user experience system, according to some embodiments.

FIG. 6 shows a flowchart of a method for defining and causing generation of an NFT associated with a physical space via a virtual user experience system, according to some embodiments.

FIG. 7 is a block diagram of an example computer system that may be used in implementing the technology described herein.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

Systems and methods exist that use smart contracts to generate and mint NFTs corresponding to real-world objects. One area of interest for NFT assets are those corresponding to individuals (e.g., athletes, celebrities, musicians, cartoon characters, etc.) and groups of individuals. Similar to public interest in collectibles (e.g., sports cards, memorabilia, etc.) corresponding to notable athletes and respective sports franchises, NFTs have been generated (e.g., minted) that digitize an athlete's likeness and teams of sports franchises as digital elements. In certain examples, a “digital element” can refer to metadata and/or other electronic identifying information that may be included in an NFT and/or may be minted as a part of an NFT. However, such digital elements have yet to be associated with physical spaces corresponding to geographic areas (e.g., geographic locations) including, for example, playing areas (e.g., pitches, fields, courts, tracks, bodies of water, courses, etc.) at, within and/or on which sporting events take place. In certain examples, a “physical space” of a geographical area can refer to a two-dimensional (e.g., based on latitude and longitude) physical space or a three-dimensional (e.g., based on latitude, longitude, and elevation) physical space of a geographical area. Further, event data associated with events occurring at, within, and/or on the physical spaces corresponding to geographic areas has yet to be associated with NFTs to provide assessments of activity associated with the respective physical spaces. In certain examples, “event data” can refer to data identifying events that are associated with a particular physical space of a geographic area. For example, event data may correspond to events that occur at, within, and/or on the particular physical space of the geographic area. Event data may be temporally-aware, such that individual events may be associated with respective times at which the events occur and may be aggregated over period(s) of time. Event data may include geospatial data identifying a geographic locations at which events occur and/or take place. For example, event data for a particular event may include metadata identifying a date and/or timestamp at which the event took place and an indication of a geographic location at which the event took place. Event data may be dynamically updated and/or tracked (e.g., in real-time) by the virtual user experience platform, such that users can interact with event data associated with particular physical spaces indicated by generated NFTs.

Accordingly, systems and methods for generating (e.g., minting) NFTs associated with physical spaces of a geographic area and associating the NFTs with events corresponding to the physical spaces are described herein. A virtual user experience platform may implement the systems and methods described herein and may cause generation of the NFTs representative of respective physical spaces of geographical areas. For a particular geographic area, the virtual user experience platform may segment a digital representation of the geographic area into a number of segments each defining a physical space of the geographic area, where each of the physical spaces corresponds to a particular segment (e.g., unique segment) of the geographic area. In some cases, physical spaces of a particular geographical area defined by the segment may overlap or may not overlap and/or may have the same dimensions or variable dimensions. The virtual user experience platform may associate the NFTs with dynamic event data of their respective physical spaces and may track event data associated with particular NFTs via their respective physical spaces. In some cases, the virtual user experience platform may determine and assign values to individual events included in event data based on an event type of the events, such that event data corresponding to different NFTs and respective segments of a geographic area may be tracked, aggregated, and compared over time. The virtual user experience platform may enable users of the platform to engage with (1) the generated NFTs, (2) related event data for the generated NFTs, (3) and other users of the platform. In some instances, the systems and methods described herein may be adapted for additional use cases. For example, the systems and methods may be adapted for generating NFTs for respective segments of a playing area corresponding to a particular sports team and associating the NFTs with event data occurring at, within, and/or on the respective segments of the playing area corresponding to the NFTs. The virtual user experience platform may enable gaming (e.g., betting) based on event data associated with individual NFTs and may enable users of the virtual user experience platform to exchange ownership of NFTs (e.g., via buying, selling, auctioning, and/or trading).

In some embodiments, the systems and methods described herein provide a solution for representing a physical space within a geographic area using a digital, unique token. Further, the systems and methods described herein provide solutions for verifying, tracking, and recording event data for events that take place on, at, above, and/or within physical spaces of the geographic area by minting event data as a part of NFTs associated with respective physical spaces.

### Some Embodiments of a Virtual User Experience Platform

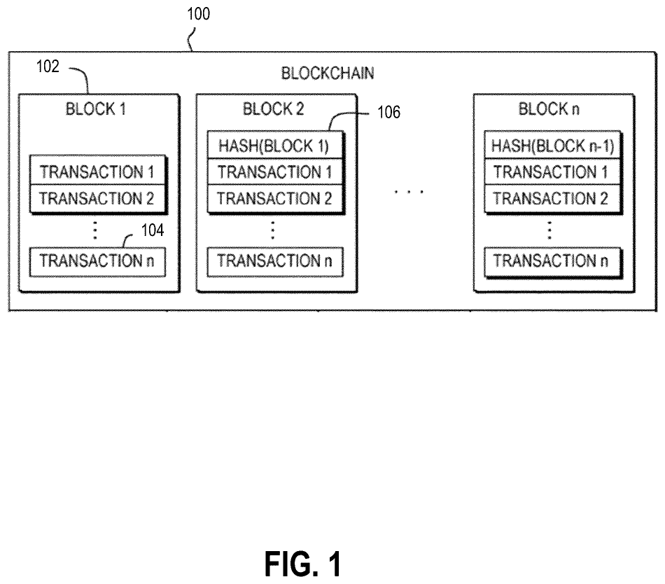

Referring to FIG. 1, a blockchain 100 includes a plurality of blocks 102. Each block 102 is a data structure that includes data representing transactions 104, for example, smart contracts, payment receipts, or any other transaction. Some non-limiting examples of the blockchain 100 include Tezos, Flow, Solana, Cardano, Binance Smart Chain, Ethereum, Polygon, WAX, and Cronos blockchains. The blockchain 100 may be any suitable blockchain network configured to support smart contracts and/or NFTs. An example of a smart contract standard that may be used by the blockchain 100 (e.g., an Ethereum blockchain) to mint NFTs is the ERC-721 standard, which may be used by the smart contracts described herein to mint and/or update NFTs. Another example of a smart contract standard that may be used by the blockchain 100 (e.g., an Ethereum or Polygon blockchain) to mint NFTs is the ERC-1155 standard, which may be used by the smart contracts described herein to mint and/or update NFTs. In some cases, the blockchain 100 may mint fungible tokens as additional versions of NFTs (e.g., for multiple tokens corresponding to a same physical space) as described herein using an ERC-20 standard. In some cases, the blockchain 100 may be a proof of stake (POS) blockchain, a proof of work (PoW) blockchain, or a proof of authority (PoA) blockchain. In some cases, smart contracts operated by the blockchain 100 may be able to atomically exchange a first token for a second token (e.g., a first NFT for a second NFT). As described above, as new transactions 104 are submitted to the blockchain 100 and validated, additional blocks 102 are generated and appended to the blockchain 100. Each new block 102 also includes a hash 106 of the immediately previous block 102. For example, block 2 includes a hash of block 1, block n includes a hash of block n−1, etc.

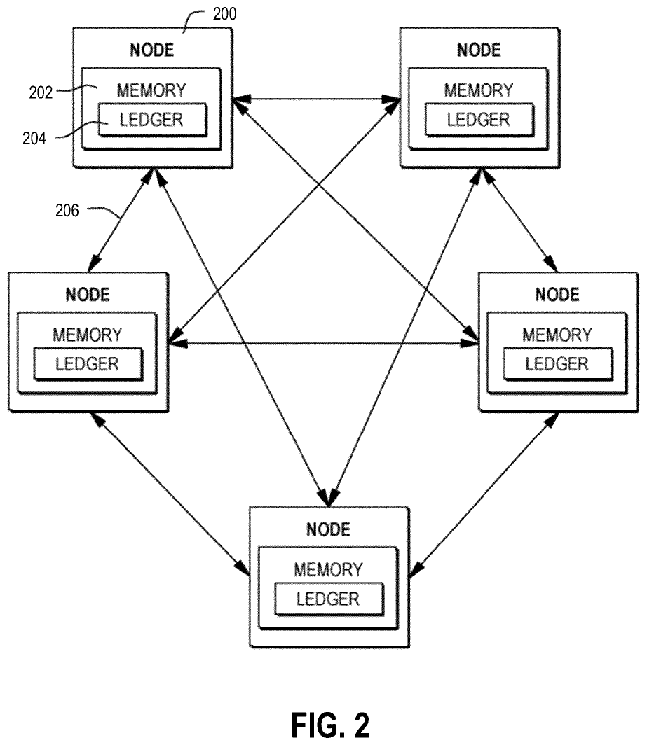

Referring to FIG. 2, in some aspects, a blockchain 100 is stored in a decentralized manner on a plurality of nodes 200, e.g., computing devices located in one or more networks. Nodes 200 may each include a memory 202 that stores at least a portion of a ledger 204 of blockchain 100. Ledger 204 includes any data blocks 102 that have been validated and added to the blockchain 100. In some aspects, every node 200 may store the entire ledger 204. In some aspects, each node 200 may store a portion of ledger 204. In some aspects, some or all of blockchain 100 may be stored in a centralized manner. Nodes 200 may communicate with one another via communication pathways 206, e.g., wired or wireless connections, over the internet, etc. to transmit and receive data related to ledger 204. For example, as new data blocks 102 are added to ledger 204, nodes 200 may communicate or share the new data blocks 102 via communication pathways 206.

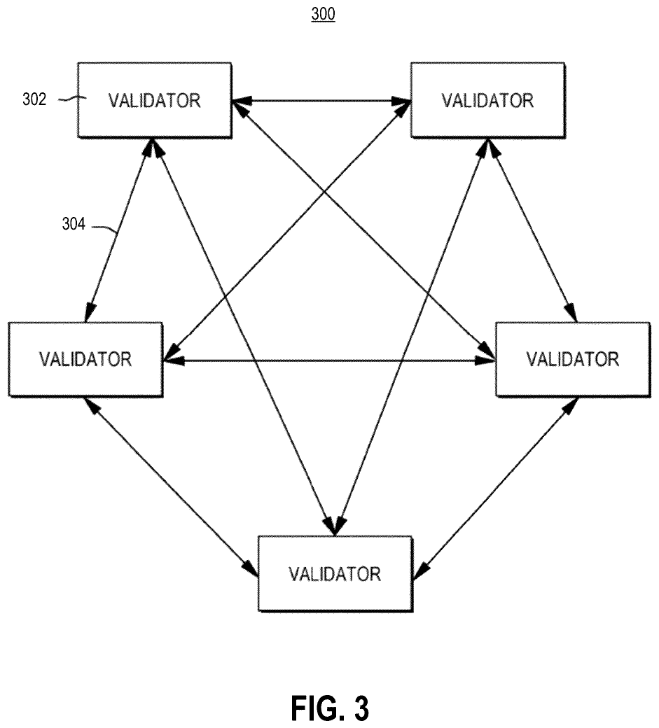

Referring to FIG. 3, any transactions 104 submitted to blockchain 100 are validated by a set of validator nodes 300 associated with blockchain 100. For example, transactions 104 may be transmitted to one or more of the validator nodes 300 and may be shared between the validator nodes 300 for validation and consensus. Each validator node 302 determines whether a transaction 104 is valid and whether the transaction 104 complies with the rules of the blockchain 100. The validator node 302 adds a plurality of the validated transactions 104 to a data block 102 and submits the data block 102 for consensus by all or some of the other validator nodes. The other validator nodes 302 then vote “for” or “against” appending the data block 102 containing the transactions 104 to the blockchain 100. A consensus of the set of validator nodes 300, e.g., a threshold number of identical votes “for” or “against”, is required to allow or deny the data block 102 to be appended to the blockchain 100. In some aspects, one or more of nodes 200 may also be validator nodes 302. In some aspects, nodes 200 that are not validator nodes 302 may perform processing such as, for example, receiving transaction submissions, providing member services, delivering events to applications, handling application programming interface (API) requests from users, or other similar functions. In this manner, the processing power of the validator nodes 302 may be preserved for generating new blocks, reaching consensus, and monitoring the other validator nodes 302. Validator nodes 302 may communicate with one another via communication pathways 304, e.g., wired or wireless connections, over the internet, etc., to transmit and receive data. For example, as new data blocks 102 are generated by validator nodes 302, validator nodes 302 may communicate or share the new data blocks 102 and transmit and receive consensus messages via communication pathways 304.

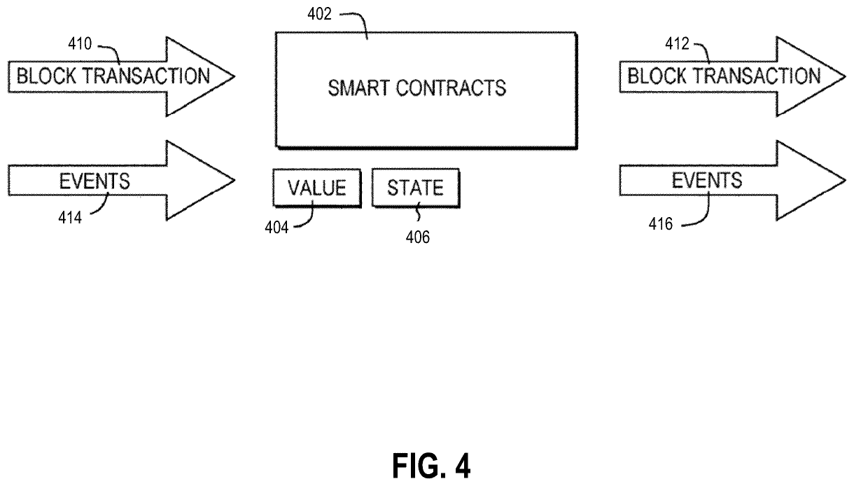

Referring to FIG. 4, an example smart contract 402 is illustrated including a value 404 (e.g., a numerical value, monetary value, or any other value), a state 406 of the smart contract (e.g., a number of items of a product sold in all retail outlets of a firm, or other similar information that may be dependent on other sources). In some aspects, smart contract 402 may receive value 404 from a transaction in a block 410, or aggregated from multiple transactions in a block 410, and the value 404 may be sent to another smart contract via a transaction 412. Smart contract 402 may also receive information about the state 406 from an event 414, or aggregated from multiple events 414, and the state 406 may be sent as an event 416 to another smart contract.

In some embodiments, a virtual user experience platform may be configured to enable and cause generation (e.g., creation or minting) of NFTs associated with physical spaces of a geographic area (e.g., geographic location), where each physical space is associated with a respective NFT by digital element(s) included in the NFT that are representative of the physical space. The virtual user experience platform may generate and interface with one or more smart contracts corresponding to a blockchain to cause generation of each of the NFTs. The virtual user experience platform may be agnostic to a type of blockchain communicatively connected to the virtual user experience platform, such that the virtual user experience platform may operate with a number of different blockchains. In certain examples, the NFT may refer to a unique digital token stored (e.g., recorded) on a blockchain and corresponding to (e.g., owned by) a particular digital wallet (e.g., based on private and public key(s) associated with the digital wallet). The NFT may be include a digital element representative of a physical space of a geographic area and may include metadata identifying the physical space. For example, the metadata may indicate the boundaries (e.g., based on latitude, longitude, and/or elevation) corresponding to the physical space at the geographic area. In some embodiments, terms and/or functions of the smart contract(s) may be defined by the virtual user experience platform.

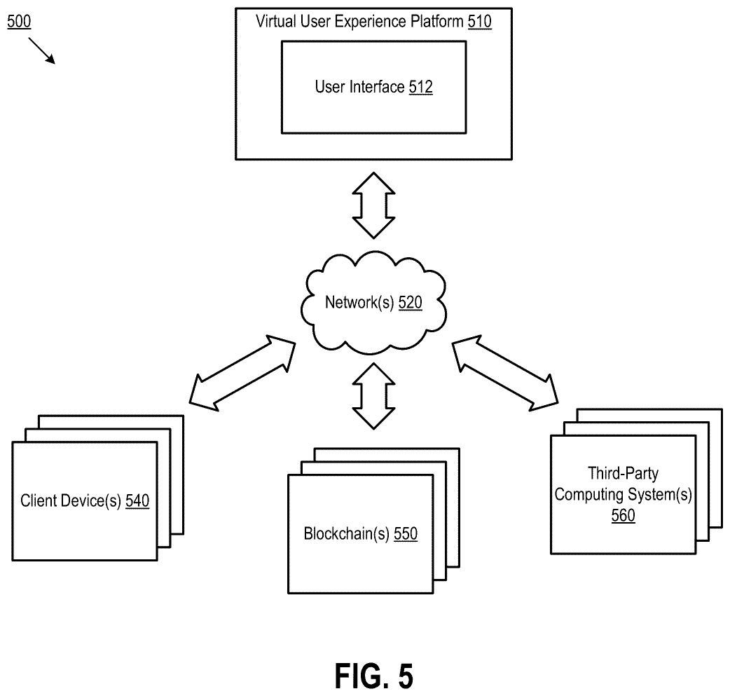

Referring to FIG. 5, an example of a virtual user experience system 500 is shown, according to some embodiments. As shown in FIG. 5, the virtual user experience system 500 may include a virtual user experience platform 510, one or more client devices 540, one or more blockchains 550, and one or more third-party computing systems 560. The virtual user experience platform 510 may operate on one or more computing devices (e.g., server computing devices) and may be accessible via one or more networks 520. In some cases, at least a portion of the virtual user experience platform 510 may operate in a cloud computing system. The virtual user experience platform 510, the client computing device(s) 540, the blockchains 550, and/or the third-party computing system(s) 560 may be communicatively connected via the one or more networks 520. In some cases, an end-user of the virtual user experience platform 510 may access and communicate with the virtual user experience platform 510 using a client computing device 540.

In some embodiments, the one or more client computing device 540 may communicate and/or otherwise interact with the virtual user experience platform 510. Some non-limiting examples of the client computing device 540 can include personal computers and mobile computing devices (e.g., mobile phones, tablets, etc.). In some cases, the virtual user experience platform 510 may include a user interface 512. The user interface 512 may be accessible via the one or more networks 520. In some cases, the user interface 512 may be a graphical user interface that can be displayed by a display device (e.g., connected to and/or included with a client computing device 540). For example, the user interface 512 may be available on a web page accessible via the one or more networks 520 (e.g., via the internet and/or an intranet) using a URL and web browser and may be displayed via a display device connected to a client computing device 540. In some cases, the user interface 512 may be made available as an application that can operate on a client computing device 540, where the user interface 512 may access and communicate with the virtual user experience platform 510 via an API. A user may access the virtual user experience platform 510 using an account associated with the user. An account associated with the user may include unique identifier associated with the user and identifying information for the user. In some cases, an account associated with a user may be associated with a digital wallet as described herein.

In some embodiments, the virtual user experience platform 510 may be communicatively connected to blockchain(s) 550 and related blockchain network(s) of nodes via the one or more networks 520. The blockchain(s) 550 may include features for a blockchain (e.g., blockchain 100) as described herein. For example, at least one of the blockchains 550 may be analogous to the blockchain 100 described herein. In some cases, the virtual user experience platform 510 may cause generation of NFTs recorded on one or more of the blockchain(s) 550. Each of the generated NFTs may include digital element(s) indicative of a respective physical space of a geographic area. Digital element(s) included in an NFT generated via the virtual user experience platform 510 may be generated by the virtual user experience platform 510. Examples of data included in a data object may include a name, description, image, animation uniform resource locator (URL), and attribute data for a physical space of a geographic area. In some cases, a digital element included in an NFT generated via the virtual user experience platform 510 may include a segment of a digital representation of a geographic area, where the defines a location and/or dimensions of physical space within the geographic area.

In some cases, a geographic area from which physical spaces are derived may be associated with an entity. One example of the entity can be a sports franchise, where the geographic area is a home playing area of the sports franchise. In some cases, NFTs generated based on the virtual user experience platform 510 may be associated with (e.g., owned by) a digital wallet corresponding to (e.g., managed by) the virtual user experience platform 510 and/or an administrator of the virtual user experience platform 510. NFTs associated with a digital wallet corresponding to the virtual user experience platform 510 may be acquired, exchanged, and/or purchased by individual users of the virtual user experience platform 510, such that ownership of the NFTs is transferred to digital wallets corresponding to the individual users.

In some embodiments, NFTs generated based on the virtual user experience platform 510 may be periodically re-minted and/or otherwise updated to include indications of event data and associated values of the NFTs as described herein. NFTs that are purchased and/or otherwise received by a user of the virtual user experience platform 510 (e.g., via the user interface 512) may be received by a digital wallet defined by the user. In some cases, the virtual user experience platform 510 may cause generation of a number of digital wallets (e.g., including digital wallet addresses, public keys, and/or private keys) for use with NFTs generated based on the virtual user experience platform 510. The digital wallets may be associated with (e.g., owned, controlled, and/or managed by) users of the virtual user experience platform 510. In some cases, the digital wallets may include custodial wallets and/or non-custodial wallet. In some cases, at least some of the custodial wallets may be hosted by the virtual user experience platform 510. As an example, each user of the virtual user experience platform 510 may have an associated custodial digital wallet that is made available by the virtual user experience platform 510.

In some embodiments, the virtual user experience platform 510 may cause generation of an NFT associated with a physical space of a geographic area. The virtual user experience platform 510 may cause generation of NFTs for a number of physical spaces (e.g., segments of a playing area) of a particular geographic area, such that the geographic area is represented by a number of NFTs corresponding to the physical spaces of the geographic area. The virtual user experience platform 510 may cause generation of NFTs for a number of geographic areas. For example, the virtual user experience platform 510 may perform a method described herein for a number of geographic areas corresponding to playing areas of different sports franchises. To generate an NFT associated with a physical space of a geographic area, the virtual user experience platform 510 may receive information representative of the geographic area (referred to as “location information”). The location information may include an entity (e.g., sports franchise or team) associated with the geographic area and/or spatial information defining boundaries of physical space(s) of the geographic area, elevation of the geographic area, and/or coordinates (e.g., latitude and longitude) of the geographic area.

In some embodiments, to define the physical space associated with a particular NFT, the virtual user experience platform 510 may segment a digital representation of a geographic area into a number of segments for a number of physical spaces, where each segment of the digital representation of the geographic area defines a location and/or dimensions of a particular physical space within the geographic area. The received location information may be used to generate the digital representation of the geographic area and/or determine the physical space defined by a particular segment. The physical spaces of the geographic area defined by the segments may have the same dimensions or variable dimensions. The physical spaces of the geographic area defined by the segments may be overlapping or non-overlapping. Physical spaces of a geographic area that are non-overlapping may be unique, such that a first physical space does not share a portion of the geographic area with any other second physical space. As an example, the virtual user experience platform 510 may segment a digital representation of a playing area of a sporting event into a number of segments (e.g., 100-10000 segments) of the playing area, where each segment defines a respective physical space of the playing area having dimensions of 1 meter by 1 meter. When a geographic area is a playing area of a sporting event, some non-limiting examples of the playing area can include a pitch, field, court, rink, track (e.g., racetrack), course, body of water (e.g., a pool, river, lake, ocean), table, and/or any other geographic area and/or target at, on, above, and/or within which a sporting event occurs (e.g., takes place). In some cases, the physical space may be a two-dimensional space or a three-dimensional space.

In some embodiments. based on segmenting a digital representation of a geographic area of the physical space, the virtual user experience platform 510 may generate a digital element including the segment and associated with the physical space defined by the segment. The generated digital element may include one or more additional data indicative of the defined physical space. Examples of data included in a digital element may include a name, description, image, animation uniform resource locator, and attribute data for a physical space of a geographic area. In some cases, the digital element may include an indication of the dimensions (e.g., boundaries) and/or location (e.g., coordinates) of the defined physical space within the geographic area, such that event data occurring at, on, above, and/or within the selected physical space may be tracked via the virtual user experience platform 510 and associated with the NFT corresponding to the defined physical space as described herein.

Based on the generation of the digital element, the virtual user experience platform 510 may send a communication (e.g., instructions) to a smart contract operating on one of the blockchain(s) 550 (e.g., via a blockchain oracle and/or the one or more networks 520), where the communication includes the generated digital element for minting in an NFT. In some cases, the communication can include an indication of a digital wallet corresponding to (e.g., managed by) an entity that operates the virtual user experience platform 510, an administrator of the virtual user experience platform 510, or a user of the virtual user experience platform 510. Based on receiving the communication from the virtual user experience platform 510 (e.g., via the blockchain oracle) and the communication satisfying the terms and/or functions of the smart contract, the smart contract operating on the blockchain 550 may execute to generate and mint an NFT including and/or indicating the digital element. For example, the newly minted NFT may include the digital element including (i) a segment defining a physical space of a geographic area (e.g., segment of a playing area) and (ii) a name, description, image, boundaries, coordinates, and/or other identifying information of the physical space. In some cases, the digital element may identify an entity and/or individual associated with the physical space. For example, the digital element may identify a sports franchise or athlete associated with the physical space. The minted NFT may be added (e.g., appended) to the blockchain 550 as described herein and may be recorded on the blockchain 550 as corresponding to (e.g., owned by) a digital wallet corresponding to the virtual user experience platform 510, an administrator of the virtual user experience platform 510, or a user of the virtual user experience platform 510. After minting, the NFT may be offered for sale and/or exchange via the virtual user experience platform 510 by the owner of the NFT.

In some embodiments, the virtual user experience platform 510 may generate a number of NFTs associated with a number physical spaces of a geographic area. For example, when the geographic area is a home playing area of a sports franchise and the physical space is a segment of (e.g., block) of the home playing area, the virtual user experience platform 510 may generate NFTs for a number of physical spaces covering some or all of the playing area. In some cases, a physical space of a playing area of a sports franchise may be referred herein to as a “block”. In some cases, as described herein, physical spaces of a geographic area associated with generated NFTs may not overlap, such that the physical spaces defined by segments included in digital elements of the generated NFTs do not share any physical space of a geographic area. For example, generated NFTs including indications of respective subsets of a home playing area may not share any portions of the playing area. Accordingly, first event data associated with a first physical space of the playing area may not include any events included in second event data associated with a second physical space of the playing area.

In some embodiments, NFTs generated based on the virtual user experience platform 510 may be made available via the user interface 512 of the virtual user experience platform 510. The user interface 512 may display indications of available NFTs that are associated with (e.g., owned by) a digital wallet of the virtual user experience platform 510 and/or NFTs owned by users of the virtual user experience platform 510. A user of the virtual user experience platform 510 may purchase ownership of an NFT from the virtual user experience platform 510 via the user interface 512, thereby causing transfer of the NFT from a digital wallet of the virtual user experience platform 510 to a digital wallet associated with the user. As an example, a user may wish to purchase an NFT representative of a physical space included within a home playing area of their favorite sports franchise. To purchase an NFT made available by the virtual user experience platform 510, a user may be required to provide an indication of a digital wallet (e.g., corresponding to a digital wallet address, a public key, and/or a private key) at the user interface 512, such that an NFT can be associated with (e.g., transferred to) the user's digital wallet. In some cases, users of the virtual user experience platform 510 may exchange (e.g., via buy, sell, auction, transfer, and/or trade) owned NFTs that were generated by virtual user experience platform 510. For example, users may exchange NFTs via a marketplace hosted by the virtual user experience platform 510 and accessible via the user interface 512. In some cases, groups (e.g., packs) of NFTs generated based on the virtual user experience platform 510 may be made available via a user interface 512 of the virtual user experience platform 510. For example, a group of NFTS associated with physical spaces of a geographic area corresponding to an entity may be made available for purchase via a user interface 512 of the virtual user experience platform 510.

In some embodiments, as described herein, the virtual user experience platform 510 may aggregate and track event data associated with physical spaces of geographic areas that are associated with the generated NFTs. In some cases, the virtual user experience platform 510 may receive event data from at least some of the third-party computing system(s) 560. For example, the virtual user experience platform 510 may periodically and/or continuously receive event data from at least some of the third-party computing system(s) 560 as the events corresponding to the event data take place.

In some cases, the virtual user experience platform 510 may receive event data for events corresponding to a number of physical spaces of geographic areas. As an example, the virtual user experience platform 510 may receive (e.g., fetch and/or otherwise obtain) event data from a third-party computing system 560 via an API. The event data may include temporal data and/or geospatial data for events occurring on, at, above, and/or within the physical spaces at respective timestamps (e.g., points in time of a sporting event) and/or geographic locations (e.g., latitude, longitude, and/or elevation) corresponding to the events. In some cases, the virtual user experience platform 510 may classify event data as corresponding to a particular geographic area of a number of geographic areas based on the geospatial data included in event data. For example, the virtual user experience platform may determine a geographic area and included physical space in which an event takes place based on the geospatial data based on comparing a geographic location indicated by the geospatial data to segments of a digital representation of the geographic area. In some cases, the virtual user experience platform 510 may classify event data by assigning an event type to each of the events included in the received event data. In some cases, event data may include events of at least two event types, where each event corresponds to a respective event type. As an example, for physical spaces corresponding to segments of a home pitch of a football sports franchise, events may be those occurring above and/or within physical spaces of the pitch and event types may include passes, attempts at goal, tackles, penalties, free kicks, goals, and/or cautions.

In some embodiments, the virtual user experience platform 510 may determine a number of events for each event type from the received event data. In some cases, the virtual user experience platform 510 may determine a number of events for each event type over a period of time for a particular physical space indicated by an NFT based on the geospatial data identifying the geographic location in which the events take place as being within the physical space. As an example, for a physical space corresponding to segment of a home pitch of a football sports franchise, the virtual user experience platform 510 may determine a number tackles occurring within the physical space for a duration of a football match based on the event data identifying tackles as occurring at geographic location(s) within the physical space. In some cases, the virtual user experience platform 510 may determine a number of events for each event type over multiple periods of time for a particular physical space indicated by an NFT. The virtual user experience platform 510 may aggregate event data for a number of periods of time, geographic areas, and/or physical spaces of geographic areas (e.g., associated with generated NFTs).

In some embodiments, aggregated event data for physical spaces of geographic areas (e.g., associated with generated NFTs) may be made available for access and/or viewing at the user interface 512 of the virtual user experience platform 510. Users of the virtual user experience platform 510 may view and access event data associated with their owned NFTs, NFTs made available via the virtual user experience platform 510, and/or NFTs generated based on the virtual user experience platform 510. For example, a user may view event data associated with NFTs owned by other users and/or NFTs offered for purchase by the virtual user experience platform 510 for comparison to event data associated with the NFTs owned by the user.

In some embodiments, the virtual user experience platform 510 may assess (e.g., score) generated NFTs based on the event data corresponding the physical spaces of geographic areas indicated by the NFTs. To assess the generated NFTs, the virtual user experience platform 510 may determine and assign a respective value (e.g., numerical value, rating, score, grade, points, etc.) to each event included the event data based on at least an event type. A value of an event may be a point value, categorical value, rating, score, or any other suitable metric for assessing a value. In some cases, values of event types may be weighted, such that a first event type may have a higher assessed value (e.g., point value) than a second event type. In some cases, physical spaces associated with generated NFTs may be associated with a physical space type. The virtual user experience platform 510 may assign a weight to each physical space type. Event data for events that occur at, on, above, and/or within a physical space having a particular physical space type may have assessed values that are weighted (e.g., higher or lower) based on the weight corresponding to the physical space type. Accordingly, an event of the same event type corresponding to respective physical spaces of a first physical space type and a second physical space type may have a different value for each physical space type. As an example, for physical spaces corresponding to a pitch for football, first physical spaces positioned closer to a goal than second physical spaces may have first physical space types weighted higher than second physical space types of the second physical spaces.

Based on a number of events of and the event types of event data corresponding to a physical space associated with a generated NFT, the virtual user experience platform 510 may aggregate (e.g., sum) values for the events corresponding to the physical space indicated by the NFT and may determine a respective value for the NFT. The virtual user experience platform 510 may continuously or periodically update the value of the NFT based on newly received event data (e.g., in real-time as events occur on the physical space indicated by the NFT or periodically as event data is received from the third-party computing system(s) 560). In some cases, a first NFT may have a higher aggregate assessed value (e.g., number of points) than a second NFT based on the event data corresponding to the first NFT having a higher aggregate assessed value than the event data corresponding to the second NFT. As an example, for NFTs indicative of physical spaces of a home pitch of a football sports franchise, physical spaces located near a goal may have a higher assessed value for aggregated event data than other physical spaces located along pitch boundaries based on events occurring in the physical spaces near the goal being of a higher value event type and/or occurring more often than events occurring along pitch boundaries.

In some embodiments, event data and respective assessed values corresponding to physical spaces associated with generated NFTs may be included in the NFTs. To include the event data and the respective assessed values in an existing NFT, the virtual user experience platform 510 may send a communication (e.g., instructions) to a smart contract on the blockchain (e.g., via a blockchain oracle and/or the one or more networks 520), where the communication includes metadata indicative of the event data and assessed value for inclusion in the existing NFT. Based on receiving the communication from the virtual user experience platform (e.g., via the blockchain oracle) and the communication satisfying the terms and/or functions of the smart contract, the smart contract may execute to update and/or otherwise re-mint an existing NFT to include metadata identifying and/or otherwise indicating the event data and assessed value associated with the physical space indicated by the NFT. In some cases, event data and the related value of the event data may be periodically included in NFTs generated based on the virtual user experience platform 510. For example, an NFT including an indication of a segment of a football pitch may be re-minted periodically (e.g., after a particular period or time or after a particular event corresponding to the football pitch) to include indications of event data that occurred on the physical space of the football pitch and the related values of the events included in the event data. In some cases, event data and a value of the event data for an NFT may be based on a particular historical time period, such as the last three months, the last one year, or the last two years. For example, event data and a value of the event data that is included in a re-minted NFT may only correspond to events that have occurred in the previous one year.

In some embodiments, a smart contract used to initially mint and generate a particular NFT may be the same as a smart contract used to update and-remint the NFT. In some cases, a smart contract used to initially mint and generate a particular NFT may be different from a smart contract used to update and remint the NFT. One or more smart contracts may be used to mint and re-mint a particular NFT, where the virtual user experience platform 510 may communicate with a number of smart contracts to mint and re-mint NFTs as described herein. In some cases, instructions sent by the virtual user experience platform 510 to a smart contract to cause initial minting and generation of a particular NFT may be the same as instructions sent by the virtual user experience platform 510 to a smart contract to cause updating and reminting of the NFT. In some cases, a smart contract used to initially mint and generate a particular NFT may be different from a smart contract used to update and-remint the NFT. One or more smart contracts and one or more instructions may be used to mint and re-mint a particular NFT, where the virtual user experience platform 510 may communicate with a number of smart contracts via a number of instructions to mint and re-mint NFTs as described herein.

In some embodiments, the user interface 512 of the virtual user experience platform 510 may provide and display assessments (e.g., values) for generated NFTs based on the event data corresponding to the respective NFTs. The values may for each generated NFT may be displayed with individual indications of (i) values for events included in event data corresponding to the NFT, (ii) the timestamps and/or periods of time corresponding to the events, and (iii) event types for the events. In some cases, the virtual user experience platform 510 may provide and display rankings of values of NFTs corresponding to the same geographic area. In some cases, the virtual user experience platform 510 may determine groups of generated NFTs based on the geographic area indicated by the NFTs, the physical space indicated by the NFTs within geographic areas (e.g., similar physical spaces within similar geographic areas), and/or a context for the NFTs. A context for the NFTs may refer to a characteristic of the NFTs that may be used to associate two or more of the NFTs. As an example, a context of an NFT may be a sporting event or a sporting league, such that NFTs indicating physical spaces of geographic areas corresponding to a sporting league may be grouped by the virtual user experience platform 510.

While the above described features of the virtual user experience system 500 and included virtual user experience platform 510 describe re-minting an NFT to include (i) an indication of event data for a particular physical space associated with the NFT and (ii) a value of the NFT after the NFT is initially minted, one of ordinary skill in the art will appreciate that the event data and the value of the NFT may be included in the NFT at the time the NFT is initially minted.

Some Embodiments of a Method for Defining and Causing Generation of an NFT associated with a Physical Space

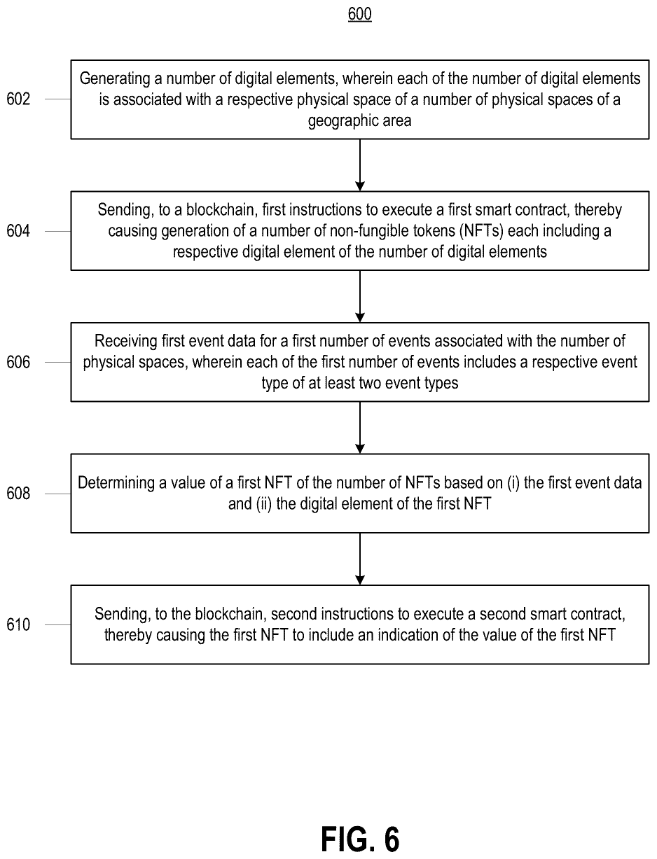

In some embodiments, the virtual user experience platform 510 may be used to define and cause generation of a number of NFTs associated with a number of physical spaces. Accordingly, the virtual user experience platform 510 as described herein may execute a method for causing generation of an NFT. The method may be used to define the contents of the NFT and cause an update to the NFT after generation. The method may be performed periodically and/or on-demand, such that an NFT can be defined, caused to be generated, and caused to be updated via the virtual user experience platform 510. Referring to FIG. 6, a flowchart of a method 600 for defining and causing generation of an NFT associated with a physical space is shown, according to some embodiments. For simplicity, the following paragraphs describe steps 602-610 of the method 600 with reference to causing generation of and updating to a single NFT associated with a physical space. However, one of ordinary skill in the art will appreciate that steps 602-610 may be performed in parallel and/or repeated for any number of NFTs for a number of different geographic areas. The method 600 may be performed, for example, by one or more processors of one or more computing devices (e.g., servers) that operate and/or host the virtual user experience platform 510.

At step 602, the virtual user experience platform 510 may generate a number of digital elements. Each of the digital elements can be associated with a respective physical space of a number of physical spaces of a geographic area. In some cases, a sporting event takes place on the geographic area and/or within the geographic area. To generate the digital elements, the virtual user experience platform 510 may generate a number of segments of a digital representation of the geographic area. Each of the digital elements may include a respective generated segment, where each segment defines a respective (e.g., unique and non-overlapping) physical space of the physical spaces of the geographic area. For example, each segment may include boundaries, a geographic location, and/or dimensions defining a particular physical space included in the geographic area. In some cases, each physical space includes (i) a two-dimensional segment of the geographic area or (ii) a three-dimensional segment of the geographic area as defined by the respective segment corresponding to the physical space. The segments and physical spaces may include other characteristics as described herein.

At step 604, the virtual user experience platform 510 may send, to a blockchain 550, first instructions to execute a first smart contract, thereby causing generation of a number of NFTs. Each NFT can include a respective digital element of the digital elements. Execution of the first smart contract on the blockchain 550 may generate the NFTs, which may be recorded on the blockchain 550 as described herein (e.g., owned by one or more digital wallets). In some cases, the virtual user experience platform 510 may receive an indication of the generation and recordation of the NFTs on the blockchain 550 (e.g., via a blockchain oracle). Each of the NFTs may include comprises a unique digital element of the digital elements, thereby associating each of the NFTs with a physical space associated with the digital element of the NFT. Features of a digital element and a minted NFT may include those described herein.

At step 606, the virtual user experience platform 510 may receive (e.g., based on fetching or obtaining) first event data for a first number of events associated with the physical spaces. The first event data may be received from one or more of the third-party computing systems (e.g., via one or more APIs). Each of the events have a respective event type of at least two event types. The events may include events having the at least two event types. Event types may be based on the geographic area including the physical spaces. The event data may include temporal data derived from a first time period occurring at the geographic area. In some cases, the event data may include temporal data from a number of time periods occurring at the geographic area. Each of the time periods may correspond to respective sporting events that take place on and/or within the geographic area. The event data may include geospatial data (e.g., such as global positioning system (GPS) data, vector data, raster data, etc.) identifying a geographic locations within the geographic area associated with the events, where the geospatial data may identify a respective geographic location within the geographic area in which each event takes place. For example, the geospatial data may identify a first geographic location within the geographic area associated with at least one event of the events. In some cases, the virtual user experience platform 510 may (i) compare the geospatial data of the event data to the segments of the digital representation (e.g., coordinate boundaries) of the geographic area and (ii) and determine, based on the comparison, at least one event of the events is associated with a first physical space of the plurality of physical spaces based on the first physical space including the first geographic location (e.g., coordinates) in which the at least one event takes place. In some cases, each event of the events takes place at, on, above, and/or within a respective physical space of the physical spaces.

At step 608, the virtual user experience platform 510 may determine a value of a first NFT of the NFTs based on (i) the first event data and (ii) the digital element of the first NFT. In some cases, virtual user experience platform 510 may determine values of each of the NFTs based on the criteria described herein. To determine the value of the first NFT, the virtual user experience platform 510 may identify, based on the digital element (e.g., associated with a first physical space) of the first NFT, a first physical space of the physical spaces that is associated with the digital element of the first NFT. The virtual user experience platform 510 may identify, based on the first event data (e.g., and included geospatial data), at least one event of the first plurality of events is associated with the first physical space as described herein. The virtual user experience platform 510 may determine, based on the event type of the at least one event, a value of the digital element associated with the first physical space. The value of the first NFT may be equivalent to the value of the digital element associated with the first physical space. The value of the first NFT may be based on each of the first plurality of events that are associated with the first physical space. The value of the first NFT may be a numerical assessment of each of the first plurality of events associated with the first physical space. In some cases, determining the value of the digital element associated with the first physical space is based on (i) the event type of the at least one event and (ii) a physical space type of the first physical space. Values for physical spaces and related NFTs may be determined and assigned as described herein.

At step 610, the virtual user experience platform 510 may send, to the blockchain 550, second instructions to execute a second smart contract, thereby causing the first NFT to include an indication of the value of the NFT. Execution of the second smart contract on the blockchain 550 may update and/or re-mint the first NFT to including the indication of the value of the NFT, which may be recorded on the blockchain 550 as described herein. In some cases, the virtual user experience platform 510 may receive an indication of the update and re-minting of the first NFT on the blockchain 550 (e.g., via a blockchain oracle). In some cases, the virtual user experience platform 510 may re-mint each of the NFTs to include their respective values. The first and second smart contracts may be the same smart contract or different smart contracts. The first and second instructions may be the same instructions or different instructions sent at the same time(s) or different time(s). In some cases, steps 604 and 610 may be combine to cause generation of a first NFT including a respective digital and value of the first NFT. In some cases, execution of the second smart contract on the blockchain 550 may cause the first NFT to include (i) the indication of the value of the first NFT and (ii) an indication of the at least one event associated with the first physical space.

In some embodiments, the method 600 can further include additional and/or alternative steps and features as described herein (not shown in FIG. 6). The virtual user experience platform 510 may determining a value of a second NFT of the NFTs based on (i) the first event data and (ii) the digital element of the second NFT. The virtual user experience platform 510 may sending, to a blockchain 550, third instructions to execute a third smart contract, thereby causing the second NFT to include an indication of the value of the second NFT. The first, second, and third second smart contracts may be the same smart contract or different smart contracts. The first, second, and third instructions may be the same instructions or different instructions sent at the same time(s) or different time(s). The virtual user experience platform 510 may receive second event data for a second number of events associated with the physical spaces. Each of the events can include a respective event type of the at least two event types. The virtual user experience platform 510 may determine an updated value of the first NFT based on (i) the first event data, (ii) the second event data, and (iii) the digital element of the first NFT. The virtual user experience platform 510 may send, to the blockchain 550, third instructions to execute the second smart contract, thereby causing the first NFT to include an indication of the updated value of the first NFT.

### Computer-Based Implementations

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

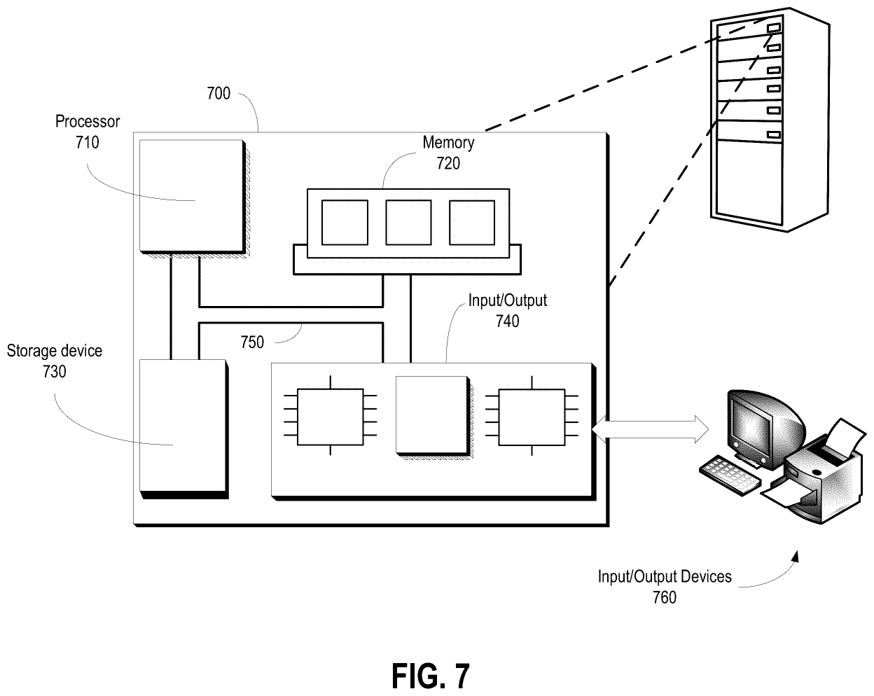

FIG. 7 is a block diagram of an example computer system 700 that may be used in implementing the technology described in this document. General-purpose computers, network appliances, mobile devices, or other electronic systems may also include at least portions of the system 700. The system 700 includes a processor 710, a memory 720, a storage device 730, and an input/output device 740. Each of the components 710, 720, 730, and 740 may be interconnected, for example, using a system bus 750. The processor 710 is capable of processing instructions for execution within the system 700. In some implementations, the processor 710 is a single-threaded processor. In some implementations, the processor 710 is a multi-threaded processor. The processor 710 is capable of processing instructions stored in the memory 720 or on the storage device 730.

The memory 720 stores information within the system 700. In some implementations, the memory 720 is a non-transitory computer-readable medium. In some implementations, the memory 720 is a volatile memory unit. In some implementations, the memory 720 is a non-volatile memory unit.

The storage device 730 is capable of providing mass storage for the system 700. In some implementations, the storage device 730 is a non-transitory computer-readable medium. In various different implementations, the storage device 730 may include, for example, a hard disk device, an optical disk device, a solid-date drive, a flash drive, or some other large capacity storage device. For example, the storage device may store long-term data (e.g., database data, file system data, etc.). The input/output device 740 provides input/output operations for the system 700. In some implementations, the input/output device 740 may include one or more of a network interface devices, e.g., an Ethernet card, a serial communication device, e.g., an RS-232 port, and/or a wireless interface device, e.g., an 802.11 card, a 3G wireless modem, a 4G wireless modem, or a 5G wireless modem. In some implementations, the input/output device may include driver devices configured to receive input data and send output data to other input/output devices, e.g., keyboard, printer and display devices 760. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 730 may be implemented in a distributed way over a network, such as a server farm or a set of widely distributed servers, or may be implemented in a single computing device.

Although an example processing system has been described in FIG. 7, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A computer-implemented method comprising:
generating a plurality of digital elements, wherein each of the plurality of digital elements is associated with a respective physical space of a plurality of physical spaces of a geographic area;
sending, to a blockchain, first instructions to execute a first smart contract, thereby causing generation of a plurality of non-fungible tokens (NFTs) each comprising a respective digital element of the plurality of digital elements;
receiving first event data for a first plurality of events associated with the plurality of physical spaces, wherein each of the first plurality of events comprises a respective event type of at least two event types;
determining a value of a first NFT of the plurality of NFTs based on (i) the first event data and (ii) the digital element of the first NFT; and
sending, to the blockchain, second instructions to execute a second smart contract, thereby causing the first NFT to include an indication of the value of the first NFT.

2. The method of claim 1, wherein a sporting event takes place on the geographic area and/or within the geographic area.

3. The method of claim 1, wherein generating the plurality of digital elements further comprises:
generating a plurality of segments of a digital representation of the geographic area, wherein (i) each of the plurality of digital elements comprises a respective segment of the plurality of segments, and (ii) each of the plurality of segments defines a respective physical space of the plurality of physical spaces of the geographic area.

4. The method of claim 3, wherein the plurality of physical spaces are non-overlapping.

5. The method of claim 3, wherein each of the plurality of physical spaces comprises (i) a two-dimensional segment of the geographic area or (ii) a three-dimensional segment of the geographic area.

6. The method of claim 1, wherein (i) the plurality of NFTs are recorded on the blockchain and (ii) each of the plurality of NFTs comprises a unique digital element of the plurality of digital elements.

7. The method of claim 1, wherein the first event data comprises temporal data derived from a first time period at the geographic area.

8. The method of claim 7, wherein the first time period corresponds to a sporting event.

9. The method of claim 1, wherein the first event data comprises geospatial data identifying a plurality of geographic locations within the geographic area associated with the first plurality of events, and wherein a first geographic location of the plurality of geographic locations is associated with at least one event of the first plurality of events.

10. The method of claim 9, further comprising:
comparing the geospatial data to a plurality of segments of a digital representation of the geographic area, wherein each of the plurality of segments defines a respective physical space of the plurality of physical spaces of the geographic area; and
determining, based on the comparison, the at least one event of the first plurality of events is associated with a first physical space of the plurality of physical spaces.

11. The method of claim 10, wherein the first physical space comprises the first geographic location.

12. The method of claim 1, wherein each event of the first plurality of events takes place at, on, above, and/or within a respective physical space of the plurality of physical spaces.

13. The method of claim 1, wherein determining the value of the first NFT of the plurality of NFTs further comprises:
identifying, based on the digital element of the first NFT, a first physical space of the plurality of physical spaces is associated with the digital element of the first NFT;
identifying, based on the first event data, at least one event of the first plurality of events is associated with the first physical space; and
determining, based on the event type of the at least one event, a value of the digital element associated with the first physical space, wherein the value of the first NFT is equivalent to the value of the digital element associated with the first physical space.

14. The method of claim 13, wherein the value of the first NFT (i) is based on each of the first plurality of events associated with the first physical space and (ii) comprises a numerical assessment of each of the first plurality of events associated with the first physical space.

15. The method of claim 13, wherein execution of the second smart contract is configured to cause the first NFT to include (i) the indication of the value of the first NFT and (ii) an indication of the at least one event.

16. The method of claim 13, wherein determining the value of the digital element associated with the first physical space is based on (i) the event type of the at least one event and (ii) a physical space type of the first physical space.

17. The method of claim 1, further comprising:
determining a value of a second NFT of the plurality of NFTs based on (i) the first event data and (ii) the digital element of the second NFT; and
sending, to the blockchain, third instructions to execute a third smart contract, thereby causing the second NFT to include an indication of the value of the second NFT.

18. The method of claim 1, further comprising:
receiving second event data for a second plurality of events associated with the plurality of physical spaces, wherein each of the second plurality of events comprises a respective event type of the at least two event types;
determining an updated value of the first NFT based on (i) the first event data, (ii) the second event data, and (iii) the digital element of the first NFT; and
sending, to the blockchain, third instructions to execute the second smart contract, thereby causing the first NFT to include an indication of the updated value of the first NFT.

19. A system comprising:
executing operations on one or more processors of one or more servers, the operations comprising:
generating a plurality of digital elements, wherein each of the plurality of digital elements is associated with a respective physical space of a plurality of physical spaces of a geographic area;
sending, to a blockchain, first instructions to execute a first smart contract, thereby causing generation of a plurality of non-fungible tokens (NFTs) each comprising a respective digital element of the plurality of digital elements;
receiving first event data for a first plurality of events associated with the plurality of physical spaces, wherein each of the first plurality of events comprises a respective event type of at least two event types;
determining a value of a first NFT of the plurality of NFTs based on (i) the first event data and (ii) the digital element of the first NFT; and
sending, to the blockchain, second instructions to execute a second smart contract, thereby causing the first NFT to include an indication of the value of the first NFT.

20. The system of claim 19, wherein generating the plurality of digital elements further comprises:
generating a plurality of segments of a digital representation of the geographic area, wherein (i) each of the plurality of digital elements comprises a respective segment of the plurality of segments, and (ii) each of the plurality of segments defines a respective physical space of the plurality of physical spaces of the geographic area.
